(19) United States
(12) Patent Application Publication
(10) Pub. No.: US 2021/0251134 A1
(43) Pub. Date: Aug. 19, 2021

(54) PICK-UP RAKE

(71) Applicant: Domenic GRECO, Ivanhoe, Victoria (AU)

(72) Inventor: Domenic GRECO, Ivanhoe, Victoria (AU)

(21) Appl. No.: 17/253,413

(22) PCT Filed: Apr. 30, 2019
(86) PCT No.: PCT/AU2019/050389

§ 371 Date: Dec. 17, 2020

(30) Foreign Application Priority Data
Jun. 28, 2018 (AU) 2018902328
Jul. 3, 2018 (AU) 2018100926

(51) Int. Cl. A01D 7/10; F16H 21/44

(52) U.S. Cl. CPC A01D 7/10; F16H 21/44

(57) ABSTRACT

A pick-up rake that has a first elongate handle having an upper end and a lower end; a first rake head mounted onto the lower end of the elongate handle; a second rake head oppositely disposed to the first rake head, the second rake head mounted onto the elongate handle via a bracket assembly enabling movement of the second rake head relative to the first rake head between a closed position and open position. The bracket assembly includes a first pivot point located on one side of the elongate handle and a second pivot point located on the opposite side of the elongate handle.

### BACKGROUND OF THE INVENTION

The present invention relates to a rake, and in particular to a pick-up rake which in addition to raking up leaves and debris also enables a user to grab and transport objects such as leaves or debris.

Generally, when raking grass, leaves or other debris before disposal, it is necessary to bend down and use the hands or a separate device to grasp the grass, leaves or other debris. Many people have problems with bending down and picking up objects from the ground which makes disposal of such debris difficult. In addition hands can be soiled by contact with the grass, leaves and other debris. A further issue is that it is only possible to pick-up a small amount with the hands.

There is a need in the industry to provide a rake which addresses the problems associated with grasping and transport of grass, leaves or other debris or at the very least ameliorate one or more disadvantages or limitations associated with the prior art.

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

### BRIEF SUMMARY OF THE INVENTION

In a first aspect, the present invention provides a pick-up rake comprising:

an elongate handle having an upper end and a lower end;

a first rake head mounted onto the lower end of the elongate handle;

a second rake head oppositely disposed to the first rake head, the second rake head mounted onto the elongate handle via a bracket assembly enabling movement of the second rake head relative to the first rake head between a closed position and an open position, wherein the bracket assembly includes a first pivot point located on one side of the elongate handle and a second pivot point located on the opposite side of the elongate handle.

In a second aspect, there is provided use of the pick-up rake of the first aspect to pick up an object(s).

By mounting the second rake head via a bracket assembly having pivot points on either side of the elongate handle, it is possible to move the second rake head relative to the first rake head without the need to clamp or pivot the second rake head on the first rake head. As a consequence, it is possible to use most types of rake heads without modification.

### BRIEF DESCRIPTION OF THE DRAWINGS

The invention will now be described with reference to the following non-limiting drawings.

FIG. 1 is a drawing of a pick-up rake in accordance with one embodiment of the present invention in the closed position.

FIG. 2 is a drawing of a pick-up rake in accordance with another embodiment of the present invention in the open position.

FIG. 3 is a drawing and cross-section of a cut-away portion of the rake of FIG. 2 showing details of a link pin and guide sleeve.

### DETAILED DESCRIPTION OF THE INVENTION

The present invention relates to a pick-up rake comprising an elongate handle having an upper end and a lower end; a first rake head mounted onto the lower end of the elongate handle; a second rake head oppositely disposed to the first rake head, the second rake head mounted onto the elongate handle via a bracket assembly enabling movement of the second rake head relative to the first rake head between a closed position and an open position, wherein the bracket assembly includes a first pivot point located on one side of the elongate handle and a second pivot point located on the opposite side of the elongate handle. The handle is suitably hollow and cylindrical in shape.

In one or more embodiments, the bracket assembly suitably includes (a) a first bracket having two ends, the first bracket connected at one end to the second rake head and connected at the other end to a first end of a second bracket thereby forming the first pivot point, and (b) a linker (or small bracket) having two ends, wherein one end of the linker is mounted proximate the lower end of the elongate handle and the other end is connected to the first bracket thereby forming the second pivot point. In one or more embodiments two first brackets and two linkers are used. In one or more embodiments the second rake head suitably includes a rod portion or is suitably mounted onto a rod. In one or more embodiments two first brackets are suitably present and suitably connected on either side of the rod or rod portion and to either side of the second bracket, and two linkers are also suitably present and suitably connected either side of the elongate handle and to the respective first bracket. The bracket(s) may be straight or angular. The rod portion or rod is suitably hollow and cylindrical in shape.

In one or more embodiments a guide sleeve may be provided for sliding movement on the elongated handle in cooperation with the bracket assembly to move the second rake head relative to the first rake head. In one or more embodiments the second bracket suitably includes a second end and the guide sleeve is connected to the second bracket proximate the second end via a third bracket (or guide bracket), suitably a ring member, thereby forming a third pivot point. In one or more embodiments the guide sleeve is suitably provided with an aperture for cooperation with at least one locking pin for locking the rake in the open or closed position. In one embodiment the locking pin is located internally within the elongate handle and has a protrusion acting as a release button which fits through an aperture provided in the elongate handle and cooperates with the aperture provided in the guide sleeve to lock the rake. The guide sleeve may be provided with a cut-out section proximate the aperture in the guide sleeve to guide the protrusion on the locking pin coming into contact with the aperture in the guide sleeve.

In one or more embodiments, in the closed position, the first rake head and second rake head are suitably in close juxtaposition such that a terminal edge of the second rake head is adjacent or flush with an internal surface of the first rake head and in the open position the terminal edge of the second rake head is suitably moved away from the surface of the first rake head thereby forming an opening.

In one or more embodiments, the first rake head and the second rake head suitably have the same or a similar shape, suitably a triangular shape. In one or more embodiments the first rake head and the second rake head are suitably not the same size. In one or more embodiments the second rake head is suitably smaller than the first rake head. In one or more embodiments the first rake head and/or the second rake head suitably includes a base and parallel spaced apart tines projecting from the base. One or more cross-members may be included to support the tines. The tines may be spaced apart at fixed or variable distances. In one or more embodiments the first rake head and/or second rake head suitably includes a base and a pan portion. In one or embodiments the first rake head and/or second rake head includes at least one angled portion proximate a terminal edge.

It will be appreciated that in one embodiment the bracket assembly functions as a lever to move the second rake head through sliding motion of the guide sleeve on the elongated handle.

The various components of the rake can be constructed of any suitable material, for example wood, metal, metal alloy (such as stainless steel, plain carbon steel), rubber, or plastic (for example, ABS (acrylonitrile butadiene styrene)) using techniques well known in the art. The metal may be coated such as chrome plated metal. Hand grips, suitably made from rubber, can be provided on the upper end of the elongate handle and on the guide sleeve for comfort. The hand grips may be molded to include grooves to assist manipulation. The components can be extruded, stamped or molded and fixed or mounted to each other by use of bolts, screws (for example 15 to 50 mm headed or headless screws), washers, spring washers, wing nuts, other suitable fasteners, press-fitting, brackets, complementary grooves/threads or otherwise connected.

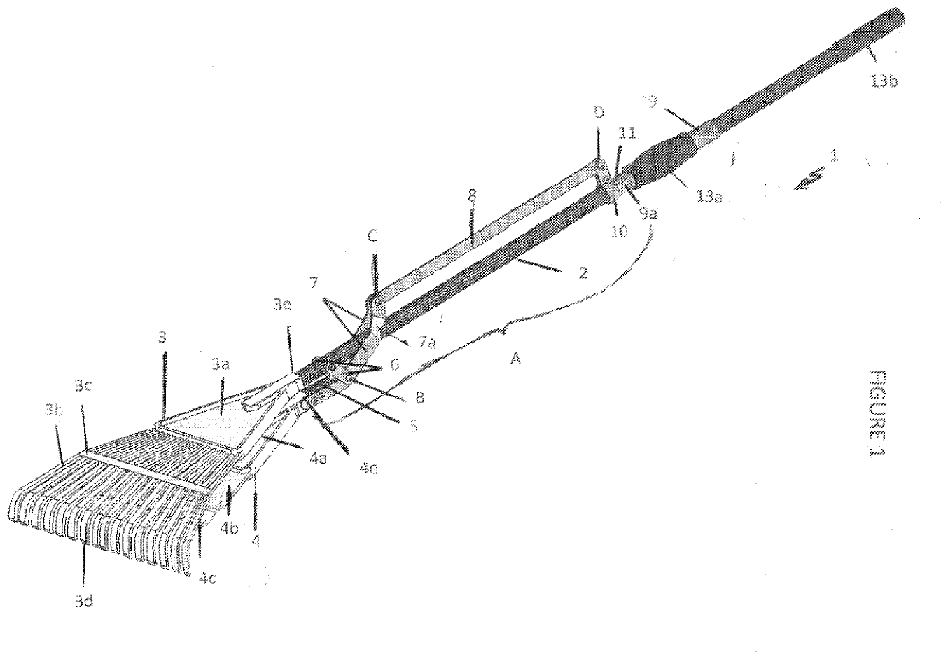

The invention will now be better understood with reference to the drawings which should not be construed as limiting on the invention. Turning to FIG. 1, this Figure shows a pick-up rake 1 in the closed position including an elongate handle 2. Mounted onto a lower end of the handle 2 is a large rake head 3. The large rake head 3 includes a rake base 3a, a plurality of parallel spaced-apart tines 3b projecting from the rake base 3a terminating in a terminal large rake head edge 3d and a cross member 3c for strengthening the tines 3b. The large rake head 3 includes an inner rake surface and an opposing outside rake surface. The large rake head base 3a is shaped to include a socket 3e to enable the elongate handle 2 to screwed (not shown) onto the large rake head base 3a (although it is possible for the rake base to include an internally threaded bore shaped to receive an externally threaded portion of the elongate handle or another attachment means may be used). It will be seen from the drawing that the tines 3b are suitably angled downwardly from the cross-member towards the terminal large rake head edge 3d with a further sharper angle proximate the terminal large rake edge 3d enabling the tines 3b to contact the ground and to assist raking

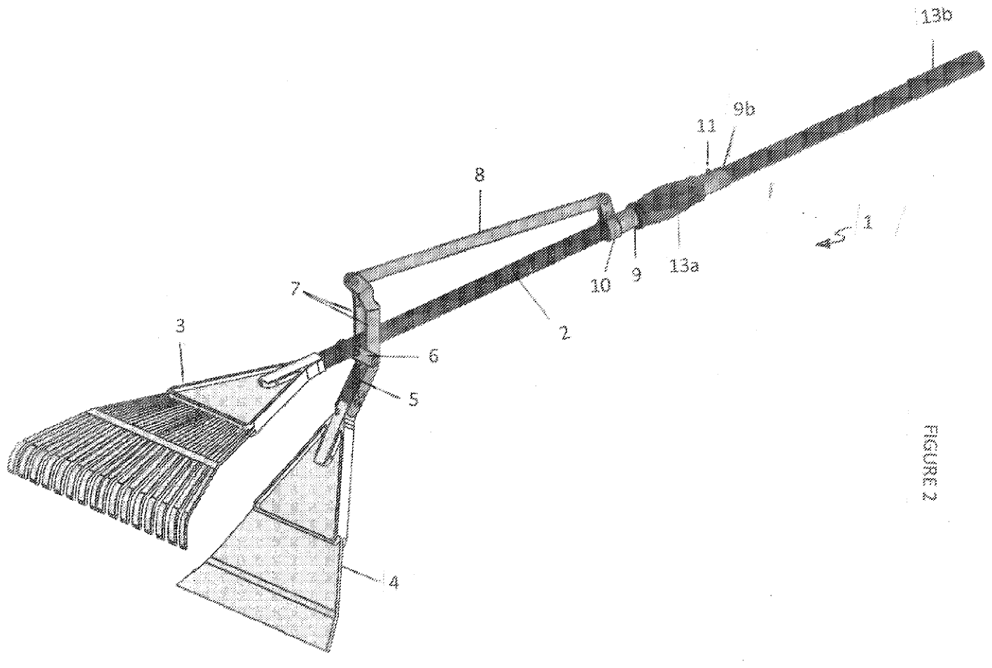

Also mounted (via a bracket assembly) onto the handle 2 oppositely disposed to the large rake head 3 is a small rake head 4 which is similar in size and shape to the large rake head 3. The small rake head 4 has a foreshortened terminal small rake head edge 4c allowing the small rake head 4 to be seated above the terminal large rake base edge 3d in the closed position. The small rake head 4 includes a rake base 4a and pan portion or plate 4b which includes an upwardly angled portion close to the terminal small rake head edge. In this way, in the closed position the large rake head 3 and small rake head 4 are in close juxtaposition such that a terminal edge of the small rake head 4c is adjacent or flush with an internal surface of the large rake head 3 and wherein in the open position the terminal edge of the small rake head 4c is moved away from the surface of the large rake head 3 thereby forming an opening (see FIG. 2). It will be appreciated that in the closed position shown, the close juxtaposition is achieved by the upwardly angled portion of the small rake head 4 correlating with the downwardly angled portion of the large rake head 3. In another embodiment, instead of the pan portion or plate 4b, the small rake head 4 may include tines and a cross-member similar to the large rake head 3.

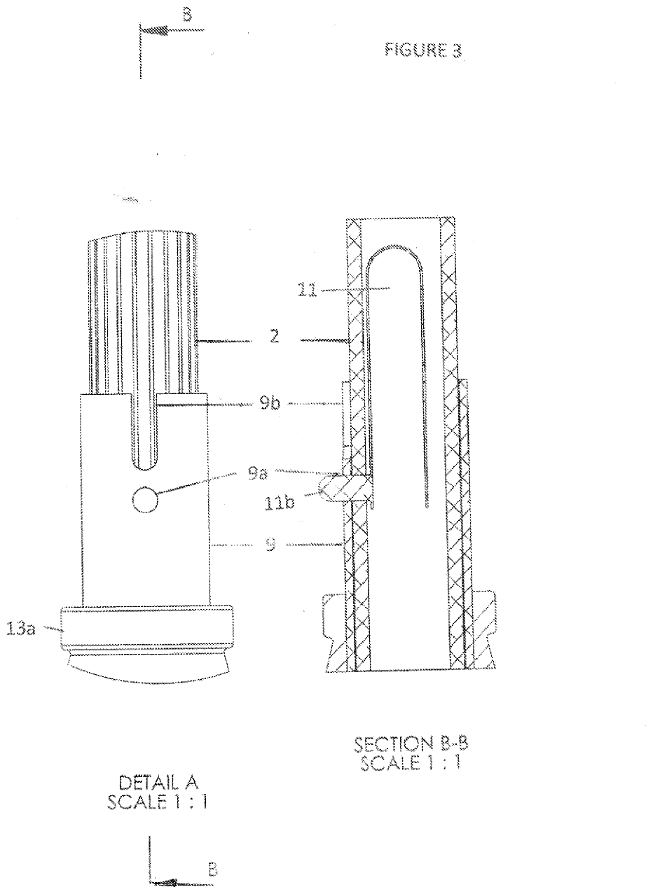

The small rake head 4 is mounted onto the elongate handle 2 via a bracket assembly A enabling movement of the small rake head 4 relative to the large rake head 3 between the closed position shown in FIG. 1 and the open position shown in FIG. 2. In this regard the small rake head 4 is shaped to include a socket 4e to enable a small rod 5 to be screwed onto the small rake head base 4a (although the small rake head 4 could be formed to include a similar rod portion). To mount the small rake head 4 onto the elongate handle 2, the ends of two small brackets or linkers 6 are mounted by screws on either side of the elongate handle 2. The other end of the small brackets or linkers 6 are screwed onto two medium brackets 7 proximate the middle of the brackets 7. This connection provides a pivot point B on one side of the elongate handle 2. The medium brackets 7 are molded or extruded into a particular shape allowing for them to be screwed at one end onto either side of the small rod 5 and screwed at their other end onto a large bracket 8. The brackets 7 suitably also have a curved indent 7a to fit over the elongate handle 2. The connection of the medium brackets 7 and the large bracket 8 provides a pivot point C on the other side of the elongate handle 2. The large bracket 8 is mounted onto a guide sleeve 9 by use of a ring member 10. The guide sleeve 9 operates by sliding movement on the elongated handle 2 in cooperation with the bracket assembly A to move the small rake head 4 relative to the large rake head 3. The connection of the large bracket 8 with the ring member 10 provides a pivot point D. The guide sleeve 9 suitably includes a hole or aperture 9a (suitably in the form of a thumb groove) which cooperates with a spring mounted lock pin 11 including a release button (with suitable lock pin inserts provided in the handle (not shown)) to lock the rake 1 in the open or closed position, the guide sleeve 9 operating to slide up and down the elongate handle 2. Alternatively, a lock pin may be hung from the ring member 10 and fitted into the hole or aperture 9a and relevant holes provided in the elongated handle (not shown) to lock the guide sleeve 9 in the open or closed position. In another alternative as shown in FIGS. 2 and 3, the elongate handle is provided internally with a lock pin 11 having a protrusion 11b acting as a release button which fits through a hole or aperture provided in the elongate handle 2. The guide sleeve 9 is provided with an a hole or aperture 9a (which in this case is positioned proximate an end of the guide sleeve opposite the mounting of the guide sleeve to the ring member 10) and a cut-out section 9b such that the protrusion 11b protrudes through the aperture 9a in the open or closed position and is guided into the aperture 9a during use using the cut-out section 9b. Hand grips 13a and 13b (which may be grooved as shown) are provided on both the guide sleeve 10 and the elongate handle 2 for comfort of a user.

In use, the rake 1 in the closed position is used to rake up leaves or other debris. In the closed position the terminal rake head edge 4c of the small rake head 4 is adjacent or in contact with a surface of large rake head 3. To pick up leaves or other debris, a user presses down on the lock pin or button 11 to release the guide sleeve 9 and then pushes down on the guide sleeve 9 enabling the bracket assembly A to pivot around pivot points B, C and D to move the small rake head 4 into the position shown in FIG. 2. The rake can be returned to the closed position by pulling upwards on the guide sleeve 9.

The rake of the present invention has the advantage that it is possible to rake up grass, leaves or other debris and pick them up with the same gardening tool. It is possible to pick up leaves or other debris without bending down and saves time by picking up more leaves than is manually possible using hands. The rake of the invention has both domestic and commercial applications. It can be used in domestic backyards, with commercial gardeners and on golf courses, for example.

From the foregoing, it will be observed that numerous modifications and variations can be effected without departing from the true spirit and scope of the novel concept of the present invention. It is to be understood that no limitation with respect to the specific embodiment illustrated herein is intended or should be inferred. The disclosure is intended to cover, by the appended claims, all such modifications as fall within the scope of the claims.

Throughout this specification and the claims that follow, unless the context requires otherwise the words “comprise”, “comprises”, “comprising” will be understood to mean the inclusion of the stated integer, step or group of integers or steps but not the exclusion of any of other integer, step or group of integers or steps.

1. A pick-up rake comprising:
an elongate handle having an upper end and a lower end;
a first rake head mounted onto the lower end of the elongate handle;
a second rake head oppositely disposed to the first rake head, the second rake head mounted onto the elongate handle via a bracket assembly enabling movement of the oppositely disposed second rake head relative to the first rake head between a closed raking position and an open pick-up position, wherein the bracket assembly includes a first pivot point located on one side of the elongate handle and a second pivot point located on the opposite side of the elongate handle.

2. The pick-up rake according to claim 1, wherein the bracket assembly includes (a) a first bracket having two ends, the first bracket connected at one end to the second rake head and connected at the other end to the first end of a second bracket thereby forming the first pivot point, and (b) a linker having two ends, wherein one end of the linker is mounted proximate the lower end of the elongate handle and the other end is connected to the first bracket thereby forming the second pivot point.

3. The pick-up rake according to claim 2, wherein the first rake head includes a rod portion or is mounted onto a rod and wherein two first brackets are present connected on either side of the rod or rod portion and to either side of the second bracket, and wherein two linkers are present and connected either side of the elongate handle and to the respective first bracket.

4. The pick-up rake according to claim 1 further comprising a guide sleeve provided for sliding movement on the elongated handle in cooperation with the bracket assembly to move the second rake head relative to the first rake head.

5. The pick-up rake according to claim 4, wherein the second bracket includes a second end and the guide sleeve is connected to the second bracket at the second end via a third bracket forming a third pivot point.

6. The pick-up rake according to claim 5, wherein the guide sleeve is provided with an aperture for cooperation with a locking pin for locking the rake in the open or closed position.

7. The pick-up rake according to claim 6, wherein the locking pin is located internally within the elongate handle and has a protrusion acting as a release button which fits through an aperture provided in the elongate handle to cooperate with an aperture provided in the guide sleeve.

8. The pick-up rake according to claim 7 wherein the guide sleeve is provided with a cut-out section proximate the aperture in the guide sleeve to guide the protrusion on the locking pin coming into contact with the aperture in the guide sleeve.

9. The pick-up rake according to claim 1, wherein in the closed position the first rake head and second rake head are in close juxtaposition such that a terminal edge of the second rake head is adjacent or flush with an internal surface of the first rake head and wherein in the open position the terminal edge of the second rake head is moved away from the surface of the first rake head thereby forming an opening.

10. The pick-up rake according to claim 1, wherein the first rake head and the second rake head have the same or a similar shape, the second rake head being smaller than the first rake head.

11. The pick-up rake according to claim 1, wherein the first rake head and/or the second rake head includes a base and parallel spaced apart tines projecting from the base.

12. The pick-up rake according to claim 1, wherein the first rake head and/or second rake head includes a base and a pan portion.

13. The pick-up rake according to claim 1, wherein the first rake head and/or second rake head includes at least one angled portion proximate a terminal edge.

14. The pick-up rake according to claim 1, wherein the second rake head has a foreshortened terminal rake head edge allowing the second rake head to be seated above a terminal first rake head base edge in the closed position.

15. Use of the pick-up rake according to claim 1 to pick up an object(s).
